(19) United States
(12) Patent Application Publication
(10) Pub. No.: US 2002/0139020 A1
(43) Pub. Date: Oct. 3, 2002

(54) Dynamic artificial landscape generator

(76) Inventors: Daj Jen Hwa, Zhejiang (CN); Lien Wien Cheng, Kwang Dong (CN)

Correspondence Address: Bacon & Thomas, 625 Slaters Lane, 4th Floor, Alexandria, VA, 22314-1176, US

(21) Appl. No.: 09/741,062

(22) Filed: Dec. 21, 2000

(51) Int. Cl. G09F 19/00

(52) U.S. Cl. 40/406

(57) ABSTRACT

A dynamic artificial landscape generator relates to a decoration, and more particularly to a decoration having a dynamic artificial landscape generator that can be placed on all kinds of tabletops. The technological solution is by using a tube with one of its end to cover the external surrounding of an air pipe at the bottom of a base, and the edge on one end of the pipe is porous, and said air pipe passes through the base and an end of the air pipe protrudes to extend into the tube, and the base is concave in shape. This utility model has the merits of its simple structure and dynamic feeling, especially suitable for the artificial aqueous landscape.

### BACKGROUND OF THE INVENTION

1. Field of the Invention

The present utility model relates to a decoration, and more particularly to a decoration having a dynamic artificial landscape generator, which can be placed on any kinds of tabletop.

2. Description of the Prior Art

As our living standard is improved constantly, the number of various decorations for working environment or living space is increasing day after day. Such decoration offers us the enjoyment of beautiful landscapes after work, releases our work pressure, and attains the purpose of being refreshed and relaxed. However, it is not difficult to find out that a vast majority of the artificial landscapes are static in nature. The esthetic and fresh feeling of the beautiful landscape will be faded away after a long period of watching. It is impractical and uneconomical to buy new ones to replace the old one frequently. Even if the artificial landscape is a dynamic one, the price will be very high, and structure complicate. Manufacturers and consumers hesitate to make and buy such respectively.

In view of the shortcomings and inconvenience of the prior art mentioned above, which are the subjects of improvements for a long time, hence the inventor of the present invention based on years of experience accumulated from the engagement in the related industry conducted extensive research to resolve the foregoing shortcomings and invented the present invention.

Therefore, the objective of this utility model is to provide a simple structure for the dynamic artificial landscape generator.

The technological solution for making the present utility model operable is elaborated as follows: It uses a tube with one of its end to cover the external surrounding of an air pipe at the bottom of a base, and the edge on one end of the pipe is porous, and said air pipe passes through the base and an end of the air pipe protrudes to extend into the tube, and the base is concave in shape.

This utility model has the merits of its simple structure and dynamic feeling, especially suitable for the artificial aqueous landscape.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows the schematic diagram of the structure of the present utility model.

FIG. 2 shows the vertical down-view of the structure of a preferred embodiment of the present utility model.

FIG. 3 shows a preferred embodiment of the present utility model when it is in use.

FIG. 4 shows the structure of another preferred embodiment of the present utility model.

FIG. 5 shows the vertical down-view of another preferred embodiment of the present utility.

### DESCRIPTION OF THE PREFERRED EMBODIMENT

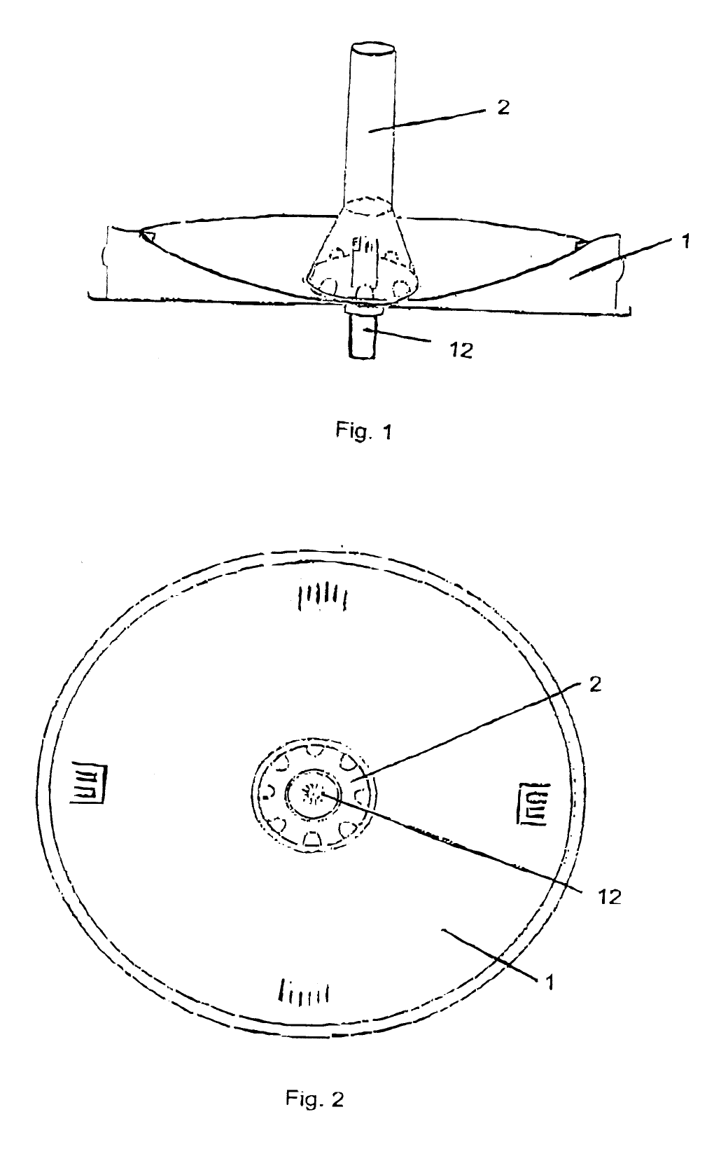

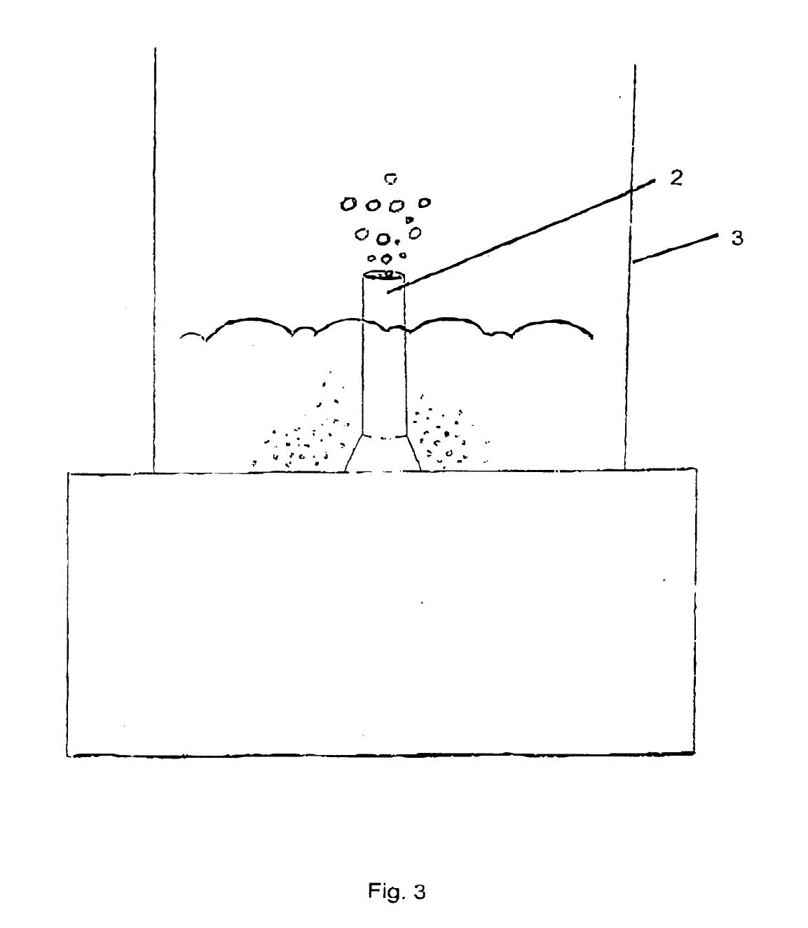

Please refer to FIGS. 1, 2 and 3. The present utility model comprises a base 1; a tube 2 having one of its end cover the external surrounding of an air pipe 12 on the base 1, and the air pipe 12 passes through the base 1 and one end of the air pipe protrudes and extends into an end of the tube 2 having a porous edge. The base is concave in shape.

When the present utility model is in use, it is placed in a transparent container 3, bottom of the container 3. When the air pump or water pump operates, the air or liquid will be pumped into the container 3 through the air pipe 12 at the bottom of the base 1. The airflow and liquid flow will enter into the tube 2 via the air pipe 12 and pushes the air or liquid to eject towards the top section. When the fluid in the tube 2 is flowing, the liquid in the container 3 will enter through the pores on the edge of the tube 2 and the seam of the base 1, and the flow will carry the color granules that piles up at the bottom of the base 1 into the holes and seam between the tube 2 and the bottom of the base 1. These colored granules will be ejected from the top section of the decoration and then dispersed on the bottom of the base 1 again for the next cycle. If the top section of the tube 2 is decorated as the crater, then the viewer will see a volcanic eruption. If the top section of the tube 2 is decorated as the fairy's finger, then the viewer will see the fluttering of colorful petals, and so on.

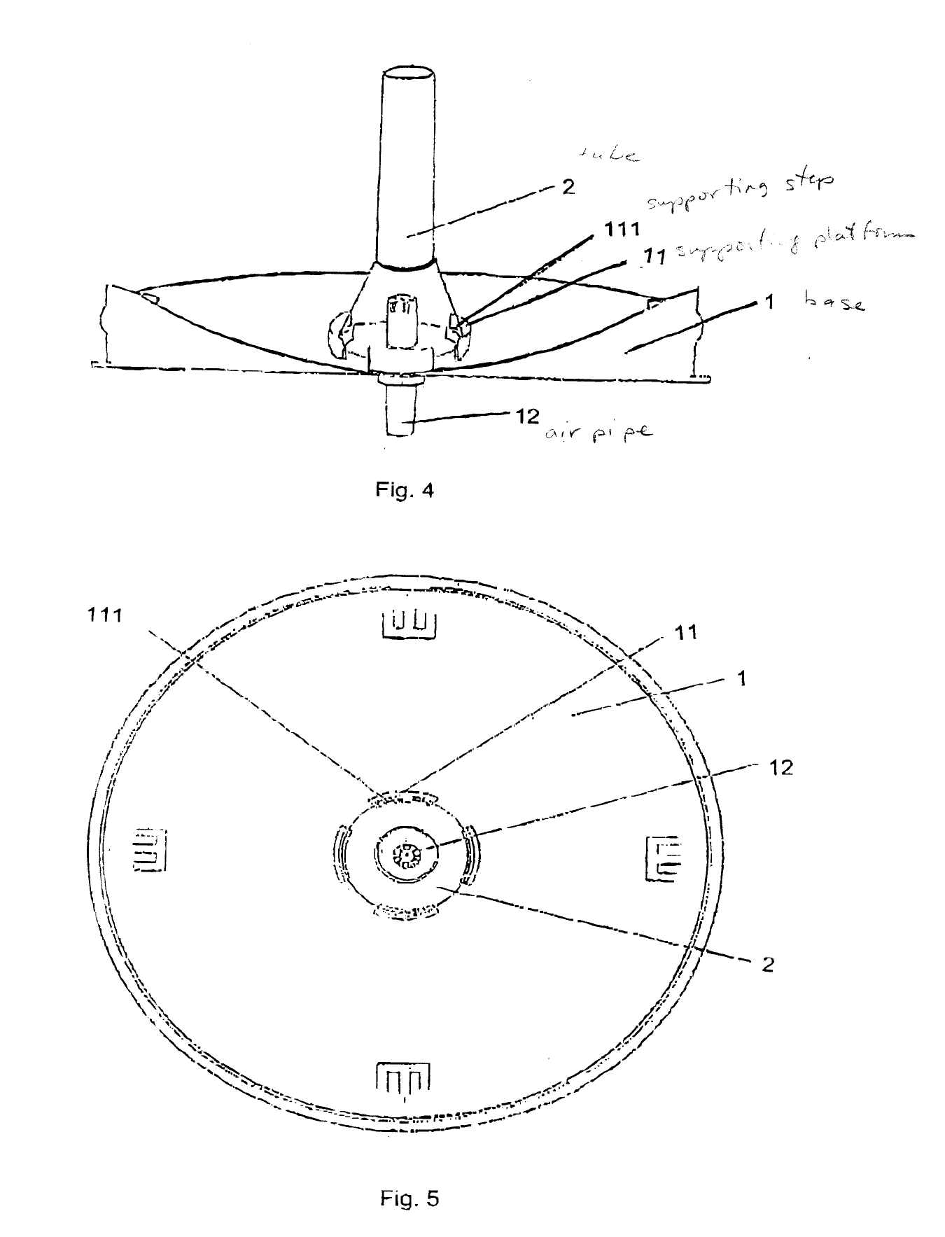

Refer to FIGS. 4 and 5. One end of the tube 2 is latched into the supporting step 111 of the supporting platform 11 of the base 1. There are a plurality of supporting platforms 11 evenly disposed on the base 1. If air or liquid is pumped into the air pipe 12 at the bottom of the base 1 by the air pump or water pump, the liquid in the container 3 will enter through the supporting platform 11 at seam between the base 1 and the tube 2. Since the tube 2 is supported by the step 111 of the supporting platform 11, the flow of the liquid will carry the colored granules that is piled at the bottom of the base 1 into the tube 2 through the supporting platform 11 and the crevices at the bottom of the tube 2 in order to have similar effect.

The inventor of the present invention based on years of experience in the related industry conducted extensive research to enhance the dynamic artificial landscape herein which is hereby submitted for patent application.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An artificial landscape generator, comprising a base (1) and a tube (2), and the base further comprising an air pipe 12 characterized in that said tube 2 has one of its end covering the surrounding portion of an air pipe (12) of said base (1).

2. An artificial landscape generator as claim in claim 1, wherein said tube 2 has a porous edge on one of its end.

3. An artificial landscape generator as claim in claim 1, wherein said air pipe (12) passes through said base (1), and one end of said air pipe (12) protrudes and extends into the porous edge of the tube 2.

4. An artificial landscape generator as claim in claim 1, wherein said base (1) is in concave shape.

5. An artificial landscape generator as claim in claim 1, wherein said tube having one of its end latch to a step (111) of the supporting platform (111) on the base (1).

6. An artificial landscape generator as claim in claim 1, wherein said base (1) having a plurality of supporting platforms evenly disposed on the base (1).
